(19) United States
(12) Patent Application Publication
(10) Pub. No.: US 2024/0161965 A1
(43) Pub. Date: May 16, 2024

(54) TRANSMITTER WITH NON-CLOSED MAGNET CORE

(71) Applicant: Phoenix Contact GmbH & Co. KG, Blomberg (DE)

(72) Inventors: Peter SCHOLZ, Brakel (DE); Yves HACKL, Hameln (DE); Christian REINHOLD, Hameln (DE)

(21) Appl. No.: 18/281,233

(22) PCT Filed: Mar. 10, 2022
(86) PCT No.: PCT/EP2022/056275

§ 371 Date: Sep. 8, 2023

(30) Foreign Application Priority Data
Mar. 12, 2021 (DE) 10 2021 106 057.5

(51) Int. Cl. H01F 27/28; H01F 27/24; H01F 27/32

(52) U.S. Cl. CPC H01F 27/2804; H01F 27/24; H01F 27/288; H01F 27/323; H01F 2027/2809

(57) ABSTRACT

A transformer includes a sequence of insulating layers layered transversely to a common plane, and a plurality of at least two galvanically separated circuits. Each circuit has at least one conductor winding, and a common magnetic core only partially surrounding the layered sequence and acting on the number of the at least two circuits. Each conductor winding is disposed on a respective one of the layers and extends parallel to the common plane. The core optionally has a core portion extending parallel to the common plane and bounds the layered sequence to one side.

### FIELD

The invention relates to a transformer and, in particular, to a transformer having a layered sequence of insulating layers transverse to a common plane and a number of at least two galvanically separated circuits, each having at least one conductor winding, and wherein a common magnetic core is included which only partially encloses the layered sequence.

### BACKGROUND

Transformers, including transformers, for the galvanically isolated transmission of power, energy and/or data, information and/or other signals are known from the prior art. These prior art transformers are usually formed either by winding a closed core, for example a toroidal core, with an electrical conductor or by inserting several core parts into a winding body or a printed circuit board which contains the necessary conductor windings. The core parts are then mechanically joined together, usually by gluing or clamping, to form a closed body. Nowadays, transformers often have a planar structure, typically in printed circuit borad technology, and conductor windings in multilayer technology.

EP 0 715 322 A1 describes, for example, a transformer whose conductor tracks are manufactured entirely in planar technology with a layered structure, in which the conductor windings are accommodated in a printed circuit board that is joined together in one piece and surrounded by a closed magnetic core.

EP 2 637 183 A2, for example, describes a planar transformer or planar transformer, which is thus characterized by a fundamentally flat design, whereby the one described there is composed of two planar magnetic bodies and two galvanically separated windings. However, the use of two magnetic bodies, which on the one hand have to be connected to each other as core parts in a complex manner, on the other hand results in a relatively large overall height.

DE 10 2015 108 911 A1 describes, for example, a planar transformer with a sandwich-type printed circuit board with at least three layers for forming electrical conductor paths and with a magnetic core which is composed of two interconnected magnetic core parts and at least partially encloses the sandwich-type structure.

EP 2 818 031 B1 describes, for example, an intrinsically safe transformer consisting of galvanically separated windings which are at least partially enclosed by at least one magnetic core forming a closed body.

DE 10 2012 003 365 B4 describes, for example, a planar, intrinsically safe transformer in a layered structure with two magnetic layers, in particular formed from ferrite plates, wherein the first magnetic layer delimits a first side of the layered structure and the second magnetic layer delimits a second side of the layered structure.

U.S. Pat. No. 6,888,438 B2 also describes, for example, a planar transformer with two ferrite plates between which the conductor windings are arranged, whereby the ferrite plates are each covered on the outside by an additional, electrically conductive shield surface.

For example, US 2020/0194162 A1 describes a planar transformer including four cores arranged in series and a primary coil unit having a plurality of primary substrates through which each of the four cores penetrates and on which primary coil patterns are formed so that magnetic flux is generated in a first direction in the first and fourth cores and in a second direction in the second and third cores, and a secondary coil unit having a plurality of secondary substrates through which each of the four cores penetrates and on which secondary coil patterns are formed, the secondary coil patterns being formed on a periphery of the four cores. The first core and the second core as well as the third core and the fourth core may each be connected to each other in a lower portion of the transformer, whereby the magnetic flux flowing in the first core and the magnetic flux flowing in the second core as well as the magnetic flux flowing in the third core and the magnetic flux flowing in the fourth core may each be formed in opposite directions in the vicinity of the coil pattern.

DE 10 2018 213 157 A1 describes, for example, a transformer with a printed circuit board and a planar winding formed as part of a conductor track of the printed circuit board and, instead of a magnetic core arranged on the planar winding, with an electrically insulating and thermally conductive insulating layer which is arranged between the planar winding and a heat sink for cooling the planar winding and thermally connects the planar winding to the heat sink. Sections of a magnetic core or of a magnetic core half, on the other hand, can be guided from one side of the printed circuit board into another side of the printed circuit board through recesses provided in the printed circuit board, between which the planar winding runs in a spiral.

### SUMMARY

The object of the invention is to demonstrate a new transformer which is different from the aforementioned prior art and which, in the case of a sandwich-like structure with at least two galvanically separated circuits arranged therein and a magnetic core which at least partially encloses the sandwich-like structure, permits a further reduction in the overall height and in the required material and thus also in the overall weight, and during the manufacture of which, in particular, the production and production monitoring steps can also be reduced.

Solutions according to the invention are represented by the transformers with the features according to the appended claims, whereby preferred further embodiments are the subject of the subclaims.

Accordingly, the invention proposes a transformer comprising a sequence of insulating layers layered transversely to a common plane and a plurality of at least two galvanically separated circuits, each circuit comprising at least one conductor winding, each conductor winding being disposed on a respective one of the layers and extending parallel to the common plane. A common magnetic core is further provided which only partially encloses the layered array and acts on the number of at least two circuits, the core having only one core part extending parallel to the common plane and bounding the layered array to one side.

In particular, in a first embodiment, it is provided for this purpose that the core part extending parallel to the common plane and delimiting the layered sequence to one side is the only core part of the core.

In a second, alternative embodiment, it is provided that the core part extending parallel to the common plane and delimiting the layered sequence to one side is a first core part from which a number of legs are provided, wherein at least in such a case through-openings are provided in the layered sequence and at least one leg extends transversely to the common plane at least partly through the through openings, wherein also in this embodiment no core part is provided on the side of the transformer opposite the core part extending parallel to the common plane. Furthermore, it is provided in this case that each conductor winding is arranged around at least one leg in each case.

In a third embodiment, the core is provided with a number of legs extending transversely to the common plane and each having a first and a second end face, wherein only each first end face is connected to a common core part extending parallel to the common plane and each second end face is without connection to a further core part, and wherein also in this case through-openings are provided in the layered sequence and at least one leg extends at least partially through the through-openings and each conductor winding is arranged around at least one leg in each case.

Since the transformer according to the solution of the invention consequently contains only a single, non-closed, magnetic body, with only a single core part thereof extending parallel to the common plane and delimiting the transformer, i.e. in particular the layered sequence, to one side, and consequently the side of the transformer opposite to this side is provided substantially open, i.e. without the arrangement of a further core part extending in parallel, the overall thickness of the transformer can again be significantly reduced compared to the prior art.

The material required to manufacture a transformer according to the invention and thus also the total weight of the transformer can also be substantially reduced.

According to a preferred further development, the invention further provides in particular for arranging, at least on the side of the transformer opposite the core part extending parallel to the common plane, a shielding surface extending parallel to the common plane, which limits the layered sequence towards this side. In this way, in particular application-specific and/or depending on the special design, possible stray fields or stray fields to be expected due to the non-enclosed magnetic body can be reduced.

If at least one of the circuits is electrically coupled according to supplementary or alternative further development with an electronic circuit that is designed to adjust the transmission behavior, further or other possibly occurring technical disadvantages such as, for example, poorer magnetic coupling can also be compensated for accordingly in a simple manner. For such an electronic circuit, circuit techniques based on the use of higher frequencies and/or compensation structures, for example, have been shown to be suitable, in particular for specific applications and/or depending on the special design.

Since the magnetic core, as a result of the only single, non-closed magnetic body, in contrast to a transformer with a closed core, thus assumes the function of a magnetic field guide rather than serving to form as perfect a magnetic circuit as possible, the magnetic core in the context of the invention can thus also be designed to be less susceptible to material and manufacturing tolerances, which moreover enables a more cost-effective manufacture.

For example, no machining of the magnetic core, such as grinding, etc., is required, as is otherwise necessary for the formation of a magnetic circle that is as perfect as possible, so that the individual steps and the associated costs in the manufacture, including the production and production monitoring, can also be reduced in this respect.

### BRIEF DESCRIPTION OF THE DRAWINGS

Further features and advantages will become apparent from the following detailed description of some preferred embodiments with reference to the accompanying drawings.

The drawings show.

FIG. 1a perspective view of a first preferred embodiment of a transformer according to the invention with a single, non-enclosed magnetic core;

FIG. 2 an exploded view of the embodiment from FIG. 1;

FIG. 3 a sectional view of the transformer from FIGS. 1 and 2;

FIG. 4 a sectional view of a second embodiment of a transformer according to the invention, namely with an E-core completely penetrating the layered sequence of insulating layers;

FIG. 5 a sectional view of a further embodiment of a transformer according to the invention with E-core and additional retaining clip;

FIG. 6 an exploded view of a further embodiment of a transformer according to the invention with E-core;

FIG. 7 an exploded view of a further embodiment of a transformer according to the invention, namely with a U-core;

FIG. 8 a sectional view of the transformer from FIG. 7;

FIG. 9 a sectional view of a further embodiment of a transformer according to the invention, specifically with a U-core that is tilted, in particular due to the manufacturing process;

FIG. 10 an exploded view of a further embodiment of a transformer according to the invention, namely with only one, in particular plate-shaped, core extending parallel to the common plane;

FIG. 11 an exploded view of a further embodiment of a transformer according to the invention, namely with only one leg starting from a core part, in particular in the form of a plate, extending parallel to the common plane, and extending transversely to the common plane; and

FIG. 12 a sectional view of the transformer from FIG. 10.

### DETAILED DESCRIPTION

In the following description of some, in particular preferred, embodiments within the scope of the invention, reference is made to the attached figures.

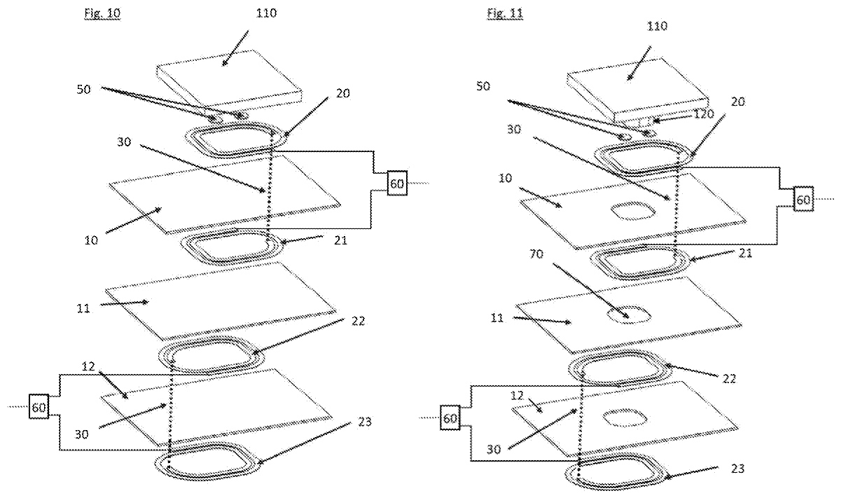

FIG. 10 shows an exploded view of an embodiment of a transformer according to the invention with a sequence of insulating layers, in the present case three layers 10, 11 and 12, layered transversely to a common plane. Such a common plane can thus be defined or predetermined in particular by such a layer itself. Furthermore, the transformer shown in FIG. 10 comprises a number of at least two galvanically separated circuits, each circuit comprising at least one conductor winding, each conductor winding being arranged in parallel with the common plane on a respective one of the layers. In the illustrated embodiment, for example, the circuits further each comprise at least two conductor windings arranged on different layers within the layered sequence. Thus, in FIG. 10, a first circuit comprises the conductor windings provided there with reference signs 20 and 21, and a second circuit comprises the conductor windings provided there with reference signs 22 and 23. To form a common circuit, for example, the conductor winding 20 arranged on the side shown as the upper side of the layer 10 according to FIG. 10 is electrically conductively connected to the conductor winding 21 arranged on the side shown as the lower side of the layer 10 according to FIG. 10 or on the side shown as the upper side of the layer 11 according to FIG. 10 via an electrical connection 30. The conductor winding 22 arranged on the side shown as the upper side of layer 12 according to FIG. 10 or on the side shown as the lower side of layer 11 according to FIG. 10, i.e. the conductor winding 22 arranged between layers 11 and 12, is electrically conductively connected to the conductor winding 23 arranged on the side shown as the lower side of layer 12 according to FIG. 10 in a corresponding manner via an electrical connection 30 to form the second circuit. Such electrical connections 30 can be made in particular by means of electrical through-platings, as are well known to the skilled person in this field.

The entirety of the layered sequence of insulating layers and the galvanically separated circuits can be expediently produced using multilayer technology and thus together form a printed circuit board.

Also shown in FIG. 10 is a common magnetic core that only partially encloses the layered sequence and acts on the number of at least two circuits. The core used according to FIG. 10 further has a single core part 110 extending parallel to the common plane, which consequently limits the layered sequence to one side, i.e. according to FIG. 10 to the upper side. The lower side according to FIG. 10 is thus substantially exposed, i.e. not covered by the magnetic core or by a core part of the core. The common magnetic core thus represents only a single, non-closed magnetic body, in particular in the form of a plate-shaped core, in contrast to a prior art transformer with a closed core. Furthermore, a ferrite plate can usefully be employed as the core.

For a stable arrangement of the core, it can be connected, for example, with an adhesive at one or more mechanical connection points 50 to one of the outer layers, e.g. layer 10 according to FIG. 10. Supplementary or also alternatively, the core can also be connected to an outer conductor winding which is no longer covered by another layer, e.g. to the conductor winding 20 according to FIG. 10.

Instead of an adhesive, the stable placement of the open core can also be achieved by creating a mechanical connection using other fastening techniques, e.g. using soldering, latching or with the help of retaining bodies, to name just a few examples.

In an embodiment as shown in FIG. 10, the use of additional shielding surfaces, as described in more detail below, has often proved to be impractical, since in such embodiments not only the stray field caused by the unclosed core but also the magnetic field required for signal and/or energy transmission would often be too strongly shielded.

Furthermore, at least one of the circuits can be electrically coupled to an electronic circuit 60 that is designed to adjust the transmission behavior. According to the illustration in FIG. 10, both circuits, i.e. the first circuit via its conductor windings 20, 21 and the second circuit via its conductor windings 22, 23 are each electrically coupled to such an electronic circuit 60. Thus, by means of these circuits 60, for example, the input voltage of the primary winding, e.g. of the first circuit, the clock frequency and/or the transmission ratio can be adjusted, in particular individually adjusted, in order to adjust the transmission behavior.

FIG. 12 shows a sectional view of the transformer from FIG. 10. The total thickness D of this transformer is thus composed of the thickness D1, i.e. the thickness resulting from the totality of the layered sequence of insulating layers and conductor windings including any solder resist 15, as well as the thickness D2 of the core part of the magnetic core extending parallel to the common plane, i.e. in this case the entire magnetic core, and the thickness D4 of the connecting means between the core and the layered sequence, i.e. according to FIG. 10 the adhesive. The total thickness D is thus the sum of D1, D2 and D4. If the entirety of the layered sequence of insulating layers and the galvanically separated circuits together form a printed circuit board, the thickness D1 corresponds to the thickness of this printed circuit board.

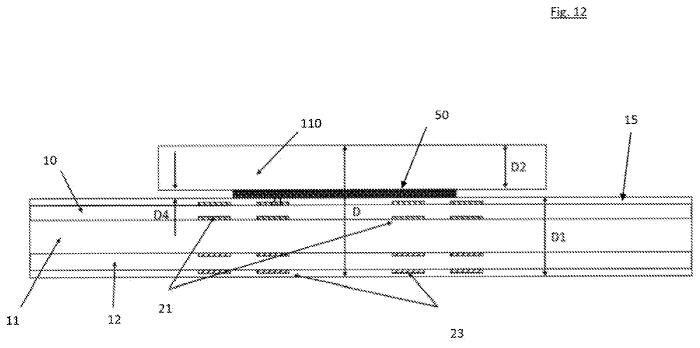

FIG. 11 shows an exploded view of a further embodiment of a transformer within the scope of the invention. The core used according to FIG. 11 also has a magnetic core part 110 extending parallel to the common plane, in particular in the form of a plate, e.g. using a ferrite plate, which consequently limits the layered sequence to one side, i.e. again to the upper side according to FIG. 11. As can be seen, on the side of the transformer opposite to the core part 110 extending parallel to the common plane, again no core part is provided.

In a modification of the embodiment example according to FIG. 10, the core part 110 extending parallel to the common plane according to FIG. 10 represents only a first core part of the core inserted according to FIG. 11, from which a number of legs are provided. In the embodiment example according to FIG. 11, a number of one leg 120 is provided. As can be seen, this one leg 120 also extends transversely to the common plane.

At least in such a case of at least one leg extending transversely to the common plane, through-openings 70 are provided in the layered sequence of insulating layers 10, 11, 12, through which just at least one such leg extends transversely to the common plane at least partially. In such a case, each of the conductor windings 20, 21, 22, 23 arranged on one of the layers 10, 11, 12 is arranged around at least one such transversely extending leg.

In the embodiment according to Fig., through-openings 70 are formed substantially centrally in all insulating layers 10, 11, 12, so that the leg 120 can penetrate this layered sequence, or, if the totality of the layered sequence of insulating layers and the galvanically separated circuits together form a printed circuit board, the printed circuit board can penetrate at least partially through these centrally formed through-openings 70. Consequently, in this embodiment with only one transversely extending leg 120, each conductor winding is also arranged around this one leg 120.

Assuming that the leg only penetrates the layered sequence or printed circuit board to the maximum extent that the leg does not protrude on the opposite side, the total thickness D can thus equally consist of the sum of D1, D2 and D4 in accordance with the embodiment according to FIG. 10 or 12.

It should be noted that even in an embodiment example as shown in FIG. 11, the additional use of supplementary shielding surfaces has often proved to be impractical, as also here the magnetic field required for signal and/or energy transmission would often be too strongly shielded. Furthermore, at least one of the circuits can be electrically coupled to an electronic circuit 60, whereby in FIG. 11 both circuits are shown in connection with such an electronic circuit 60.

With FIG. 1 to 3, a further modified embodiment compared to the embodiment shown with FIGS. 10 to 12 of an is presented, in particular a first particularly preferred embodiment of a transformer according to the invention with a single, non-closed magnetic core.

As shown, the transformer illustrated in FIGS. 1 to 3, similar to FIG. 11, again has a core with a number of legs extending transversely to the common plane, each with a first and a second end face. In the embodiment according to FIGS. 1 to 3, however, 3 legs 120, 130 and 140 are provided. Each first end face, in the figures the respective upper end face, is connected to a common core part 110 extending parallel to the common plane, and each second end face, in the figures the respective lower end face of the legs, is without connection to a further core part. In particular, the magnetic core has the shape of an E-core.

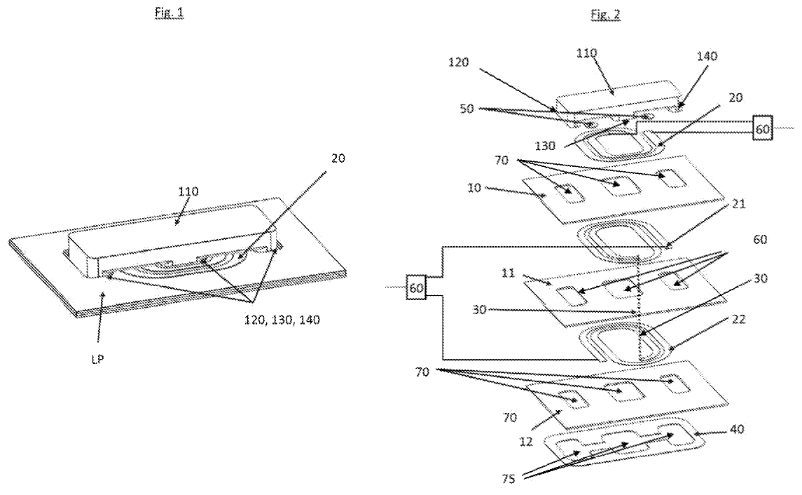

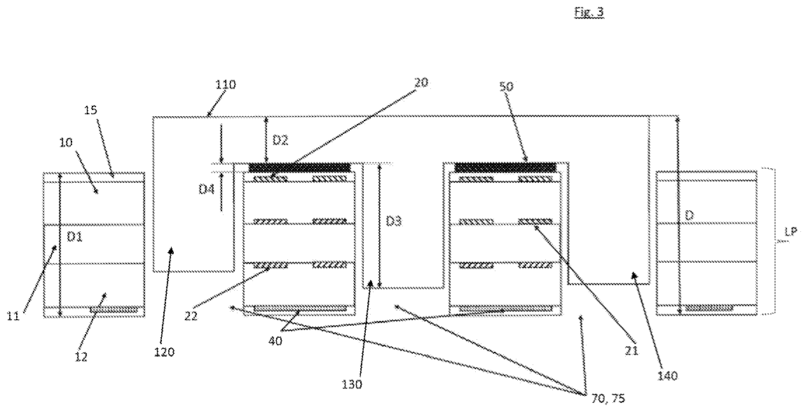

In particular, the transformer is constructed with a sequence, layered transversely to the common plane, of a total of 3 insulating layers 10, 11 and 12 and with a total of two galvanically separated current circuits, each with at least one conductor winding running parallel to the common plane and arranged on one of the layers in each case. In the embodiment example shown, however, a first circuit comprises only the conductor winding provided with reference signs 20 and the second circuit comprises the conductor windings provided there with reference signs 21 and 22. The conductor winding 21 arranged on the side of layer 12 shown as the upper side according to FIG. 2 or on the side of layer 10 shown as the lower side according to FIG. 2, i.e. the conductor winding 21 arranged between layers 10 and 11, is in turn electrically conductively connected to the conductor winding 22 arranged on the side of layer 11 shown as the lower side according to FIG. 2 via an electrical connection 30 to form the second circuit. The conductor winding 20 is thus galvanically separated from the conductor winding 21 arranged between the layers 10 and 11, whereby the respective insulating layers can be suitably dimensioned so that they satisfy the respective, required insulation requirements. For example, one requirement for the insulating layers can also be that they must be constructed from at least two layers, each of which has a certain dielectric strength. Furthermore, a requirement for the insulating layers can also be that the dielectric strength is designed in such a way that the transformer is an intrinsically safe transformer.

Consequently, in the layered sequence of insulating layers 10, 11 and 12, through-openings 70 are again provided, wherein in the illustrated embodiment example each of the layers is provided with 3 through-openings 70 each, which are in particular aligned with each other in such a way that, as illustrated, preferably all three legs 120, 130 and 140 can extend at least partially through these through-openings 70. Furthermore, each conductor winding 20, 21 and 22 is again arranged around at least one leg in each case, in the example shown around leg 130 in each case. As can be seen, the magnetic core can again be expediently connected at one or more mechanical connection points 50 to one of the outer layers, e.g. layer 10 as shown in FIG. 2. However, any solder resist layers are not shown for clarity.

The entirety of the layered sequence of insulating layers and the galvanically separated circuits is expediently made using multilayer technology and together form a printed circuit board, designated LP in FIG. 1.

FIG. 1 also shows the conductor winding 20 running on the side of the layer 10 shown as the upper side and enclosing the center leg 130 of the transformer. In the embodiment shown there, the conductor winding 20 thus runs on the outer layer of the printed circuit board LP.

Furthermore, in the embodiment shown here, a shielding surface 40 extending parallel to the common plane is preferably arranged at least on the side of the transformer opposite the core part 110 extending parallel to the common plane and limits the layered sequence towards this side.

According to the embodiment shown, this shielding surface 40 is thus located on the underside of the insulating layer 12, in particular to shield stray magnetic fields caused by the open core. In this way, interference by stray fields from neighboring transformers or other electronic circuits can also be expediently reduced by the shielding surface 40.

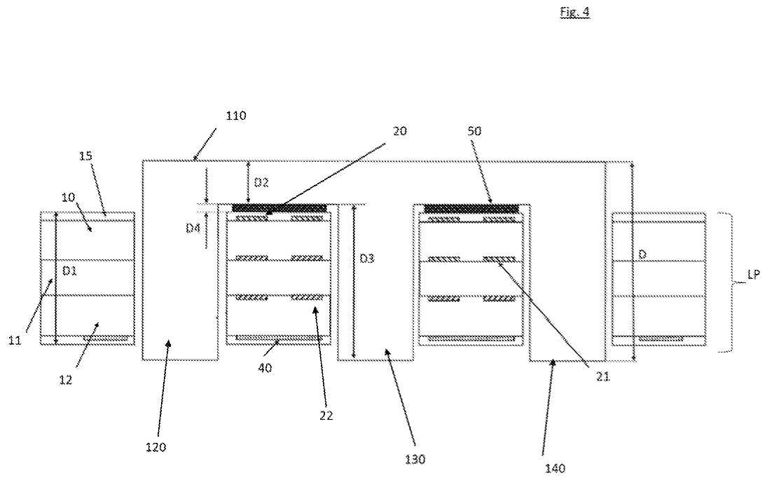

Furthermore, in a useful embodiment, this shielding surface 40 is also provided with through-openings 75 which are substantially aligned with the through-openings 70, but as can be seen in particular from FIG. 3, this is not absolutely necessary from a mechanical point of view, since the legs 120, 130 and 140 extending at least partially through the through-openings 70 do not extend to them.

However, as already mentioned, the shielding surface 40 is in a practical embodiment also formed with through-openings 75, which are substantially aligned with the through-openings 70. In this way, it can be avoided that parts of the magnetic fields are shielded which are necessary for the transmission of information and/or energy between the galvanically separated windings. In a preferred manner, the through-openings 75 may furthermore be somewhat larger in shape, so that the through-openings 70 formed in the insulating layers 10, 11 and 12 are virtually surrounded by the through-openings 75. In a particularly preferred manner, the shielding surface is also interrupted between these through-openings 75.

In turn, at least one of the circuits can be electrically coupled to an electronic circuit 60, usefully all electrically isolated circuits can be electrically coupled to a respective electronic circuit 60 for adjusting the transmission behavior, as indicated in FIG. 2, but for reasons of clarity not indicated in FIGS. 1 and 3 for reasons of clarity.

As can be seen in FIG. 3, the total thickness D of this transformer is thus composed of the thickness D1, i.e. the thickness resulting from the totality of the layered sequence of insulating layers and conductor windings including any solder resist 15, as well as the thickness D2 of the core part of the magnetic core extending parallel to the common plane and the thickness D4 of the connecting means between core and layered sequence. The total thickness D is thus again the sum of D1, D2 and D4. If the entirety of the layered sequence of insulating layers and the galvanically separated circuits, including any solder resist, together form a circuit board, the thickness D1 corresponds to the thickness of this circuit board LP (FIG. 1.

As can also be seen in FIG. 3, the legs 120, 130 and 140 with a maximum leg length D3 do not completely penetrate the circuit board.

FIG. 4 shows a sectional view of a transformer similar to the one shown in FIGS. 1 to 3 with an E-core is shown. However, at least one of the legs 120, 130 and 140 of the transformer shown in FIG. 3 completely penetrates the circuit board. In the example shown in FIG. 4, all three legs 120, 130 and 140 penetrate the circuit board LP completely. The maximum leg length D3 in this case is therefore greater than the sum of the thickness D4 and the thickness D1 (D3>D1+D4). Consequently, the total thickness D of this transformer is the sum of D2 and D3.

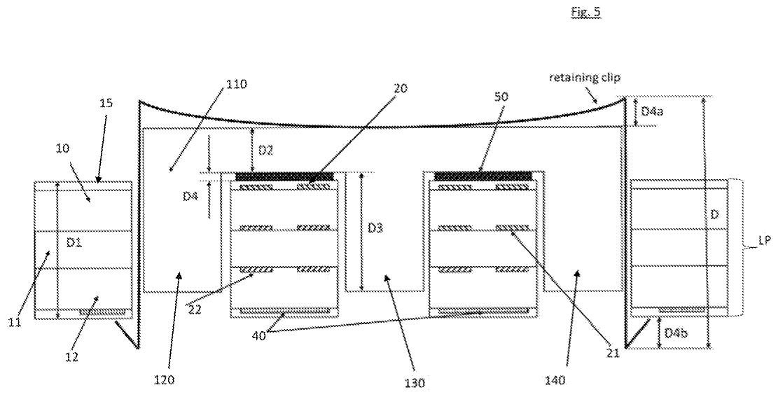

FIG. 5 shows a sectional view of another transformer similar to the one shown in FIGS. 1 to 3 with an E-core is shown.

In addition to at least one mechanical connection point 50 as described above, but optionally also only as an alternative thereto, the transformer according to FIG. 5 has a fastener for the stable arrangement of the magnetic core and the layered sequence or the circuit board LP, which has a projection D4a with respect to the core and/or a projection D4b with respect to the underside of the circuit board. As an example of such a fastener, a retaining clip is shown in the embodiment according to FIG. 5, which, for example, projects beyond the E-core by the length D4a and protrudes on the underside of the PCB LP by the length D4b. Assuming that the legs of the magnetic core do not completely penetrate the circuit board or, in the case of a protrusion 4b present on the underside of the circuit board LP, at least do not extend beyond such a protrusion, the total thickness of the transformer D in a such or similar case thus results from the sum of the thickness D1 of the printed circuit board, the thickness D2 of the core part of the magnetic core of the plate-shaped base body D2 extending parallel to the common plane, if applicable the maximum thickness D4 of the junction 50, the upper projection D4a and/or the lower projection D4b. Instead of a retaining clip as a supplementary or alternative fastener according to FIG. 5, other embodiments of fastener, in particular retaining devices, are also conceivable. For example, a retaining clip that can only be soldered on the upper side, in which the lower projection D4b=0. Also conceivable is, for example, an edge metallization of the core, which makes it possible to solder the core directly to the printed circuit board, so that both the lower projection D4b=0 and the upper projection D4a=0 are omitted. In addition, latching hooks on the magnetic core are conceivable, which latch onto the underside of the circuit board after penetration of the circuit board, so that the upper projection D4a=0 is omitted, but the lower projection D4b remains. As already mentioned, embodiments are also possible within the scope of the invention in which, alternatively, a mechanical connection point 50 is also dispensed with, so that the thickness D4 is equal to 0.

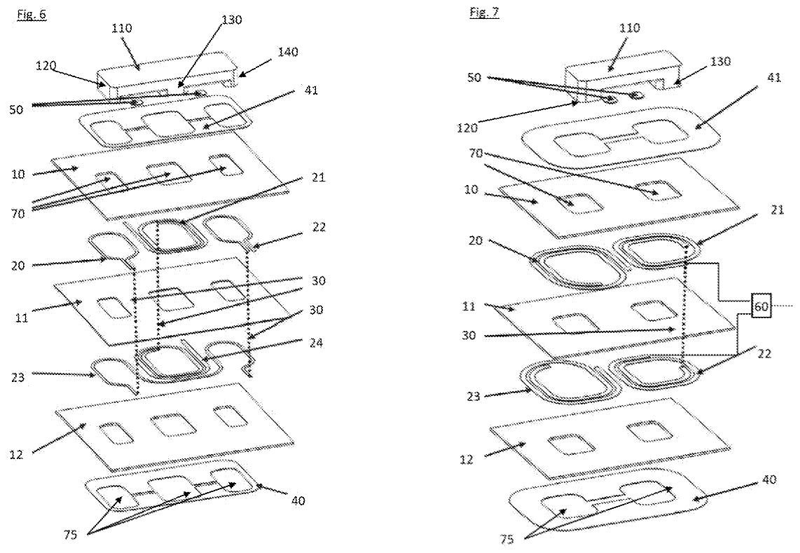

FIG. 6 shows an exploded view of another exemplary embodiment of a transformer with an E-core. A conductor winding 21 and galvanically separated conductor windings 20 and 22 are located between the insulating layers 10 and 11. The conductor winding 23, which runs between the insulating layers 11 and 12, is electrically connected to the conductor windings 20 and 22 via electrical connections 30, and the conductor winding 24, which also runs between the insulating layers 11 and 12, is electrically connected to the conductor windings 21 via an electrical connection 30. A first circuit thus comprises the two conductor windings 20 and 22 arranged in parallel on the same layer. In particular, this circuit consequently also comprises at least three conductor windings 20, 22 and 23 that, in the example shown, are arranged at least partially parallel to each other on the same layer and at least partially on different layers within the layered sequence. The skilled person will recognize that, in a variation, three conductor windings forming a common circuit can also be arranged only parallel to each other on the same layer or only on different layers within the layered sequence within the scope of the invention.

In the example shown, the three conductor windings 20, 22 and 23 enclose the outer legs 120 and 140, with the conductor winding 23 enclosing both outer legs. The two conductor windings 21 and 24 of the other circuit enclose the inner leg 120. It is obvious to an expert in this field that the correct winding direction must be observed.

The two galvanically separated circuits also have a low capacitive coupling to each other, as their respective conductor windings are arranged side by side to each other and not on top of each other on different layers. The coupling path of common-mode interference voltages can thus be reduced. For reasons of clarity in particular, the suggestion of an optional additional electrical connection of at least one of the circuits to an electronic circuit 60 has been omitted.

Again, a shielding surface extending parallel to the common plane is arranged on at least one of the layers 10, 11 and 12. In addition to a shielding surface 40 corresponding to the shielding surface described with respect to FIGS. 1 to 3, apart from the interruptions between the through-openings 75 which are not quite so pronounced in this exemplary embodiment, there is a further shielding surface 41 on the layer 10, according to the example in particular on its upper side and thus oriented towards the magnetic core part 110. This is expediently formed essentially corresponding to the shielding surface 40. By using two or, if necessary, further shielding surfaces, the stray field can be reduced even more than in the case of the embodiment shown in FIGS. 1 to 3.

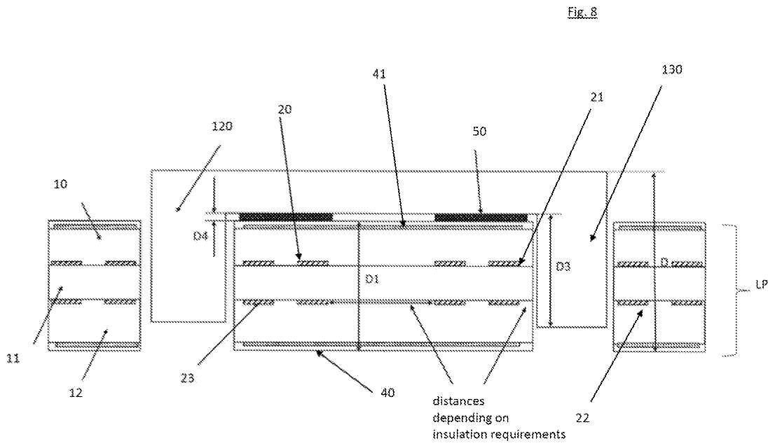

FIG. 7 shows an exploded view of another preferred embodiment of a transformer, in this case with a number of two legs 120 and 130 extending transversely from a first core part 110 extending parallel to the common plane. In particular, the magnetic core can thus be formed as a U-core. In this example, three galvanically separated circuits are further shown. As can be seen, a first circuit consists of the conductor windings 21 on the upper side of the insulating layer 11 or on the lower side of the insulating layer 10, i.e. between the layers 10 and 11, and the conductor winding 22 electrically coupled thereto by means of the electrical connection 30 between the layers 11 and 12. Both conductor windings 21 and 22 are arranged here, for example, around the leg 130, i.e. in the example shown they enclose the right leg 130 of the U-core.

The conductor winding 20, which is arranged parallel to the conductor winding 21 on the same layer, i.e. in particular between layers 10 and 11, and with which a second circuit is established, encloses the other leg 120, i.e. according to the illustration the left leg of the U-core. The conductor winding 23, which is arranged parallel to the conductor winding 22 on the same layer, i.e. in particular between layers 11 and 12, and with which a third circuit is established, also encloses the other leg 120, i.e. the left leg of the U-core as shown.

It is shown here that the magnetic coupling between the conductor windings 20 and 23 is higher than between the electrically interconnected conductor windings 21 and 22 on the one hand and the conductor winding 20 and also 23.

This can be exploited in particular to transfer information and/or energy more efficiently between the conductor windings 20 and 23 than between the other conductor windings.

For reasons of clarity, an optional but expedient electrical coupling with an electronic circuit 60 is also indicated only in relation to the first circuit by way of example.

With reference to the description of the embodiment according to FIG. 6, also in the embodiment according to FIG. 7, an appropriately adapted shielding surface 40 is preferably arranged on the underside of the layer 12 and expediently also one on the upper side of the layer 10.

It should be noted that, in principle, a transformer with a U-core can also be constructed with only two galvanically isolated circuits in a modification to FIG. 7. Depending on the intended application, combinations of the first and second circuits, of the first and third circuits or of the second and third circuits as two galvanically separated circuits are also conceivable.

From the above description, it is apparent to the skilled person that within the scope of the invention, transformers with cores other than essentially E and U cores, e.g. with a shell core, or only a plate-shaped body, and/or with three or more galvanically separated circuits can also be implemented. Also, the number of layered sequences of insulating layers and/or conductor windings accommodated on such layers may be greater than in the previously illustrated examples. Thus, these conductor windings can be arranged on different layers and/or in different layers and/or on the same layers and/or in the same layers.

FIG. 8 shows a sectional view of the transformer from FIG. 7. It can be seen that the legs 120 and 130 of the magnetic core do not completely penetrate the layered sequence, i.e. in particular the circuit board LP, in this case. However, configurations are also conceivable analogous to the embodiment according to FIG. 4, in which the core completely penetrates the circuit board and/or other connecting means, such as a retaining clip, are used in addition to or as an alternative to the mechanical connection points 50. FIG. 8 also shows by way of example that, depending on the insulation requirements, the individual circuits and the conductor windings they comprise must maintain certain minimum distances from each other and from the through-openings.

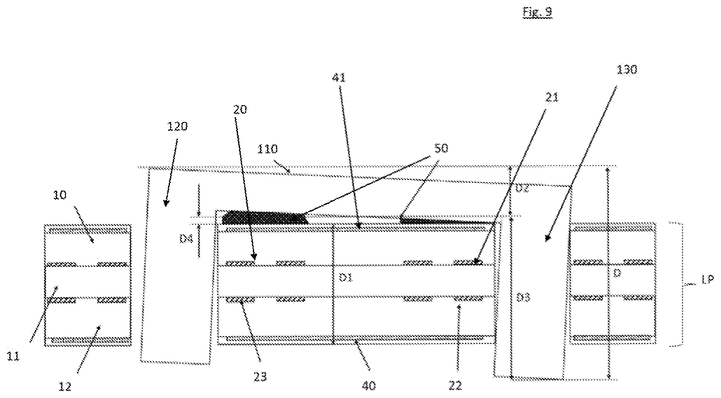

FIG. 9 shows a sectional view of another transformer with a U-core similar to the one shown in FIG. 8. In a modification, however, the transformer according to FIG. 9 shows a magnetic core that is arranged slightly tilted, in particular glued in, due to the manufacturing process. Furthermore, the core legs completely penetrate the layered sequence of insulating layers 10, 11, and 12, in particular the circuit board LP. The thickness of the connecting agent, in particular adhesive, used at the mechanical connection points 50 varies in this case and can no longer be specified, for example, by a scalar quantity. The tilt angle caused by this results in an effective thickness D4 of the connecting agent. Likewise, this also results in an effective thickness D2 of the core part 110 of the magnetic core extending parallel to the common plane, i.e. in particular of the plate-shaped base body of the magnetic core, and an effective maximum leg length D3, which depend both on the tilt angle and the thickness D4 of the connecting means at the mechanical connection points 50. The total thickness D in this example thus results from the sum of the effective thickness D2 and the effective maximum leg length D3 (D=D2+D3).

In summary, considering the above description, it can be stated that with a transformer according to the invention, i.e. in particular by using a single, non-closed core, the overall thickness and materials can be significantly reduced, which consequently enables flatter, lighter and more cost-effective transformers, i.e. in particular isolation amplifiers.

The saving of the total thickness thus results in particular from the use of only one core part extending parallel to the common plane and/or from the omission of a second core part extending parallel to this core part and parallel to the common plane on the opposite side of the transformer.

The open core according to the invention is also advantageous because temperature feedback and fluctuations in material properties, which otherwise have a major influence on the transmission behavior of transformers with closed cores, can be significantly reduced. Furthermore, in contrast to closed cores with core parts, in particular core halves, joined together for this purpose, the influence of a varying joining gap, e.g. adhesive gap, can be eliminated.

Any stray fields that may arise due to the non-closed core can advantageously be reduced by one or more shielding surfaces. As shown by the examples described, appropriate configuration of such shielding surfaces, i.e. in particular their application-specific, i.e. in particular depending on the specific design of the magnetic core and/or the respective arrangement of galvanically separated circuits, configuration with corresponding through-openings and recesses, nevertheless allow that the required magnetic field for the transmission of power, of energy and/or of data, information and/or other signals is not negatively influenced, at least not significantly reduced.

Since the magnetic coupling of the galvanically separated circuits with only one, non-closed core is lower than in the case of those with a closed core, it can, however, be expedient to use supplementary techniques for information and/or power transfer, such as are known from contactless inductive power transfer (IPT=inductive power transfer/MPT=wireless power transfer). Thus, in order to compensate for lower magnetic coupling, at least one of the circuits can be electrically coupled to an electronic circuit which is designed to adjust the transmission behavior, e.g. by correspondingly adapting the input voltage of the primary winding, the clock frequency and/or the transmission ratio.

1. A transformer comprising:
a sequence of insulating layers layered transversely of a common plane, and
a plurality of at least two galvanically separated circuits, each circuit comprising:
at least one conductor winding, each conductor winding being disposed on a respective one of the layers extending parallel to the common plane, respectively, and
a common magnetic core only partially surrounding said layered sequence and acting on said number of at least two circuits, said core having a single core part extending parallel to said common plane and bounding said layered sequence to one side.

2. A transformer comprising:
a sequence of insulating layers layered transversely to a common plane, and
a plurality of at least two galvanically separated circuits, each circuit comprising:
at least one conductor winding, and
a common magnetic core only partially enclosing the layered sequence and acting on the plurality of at least two circuits, the core having a first core part extending parallel to the common plane and a plurality of legs extending therefrom,
wherein through-openings are provided in the layered sequence and at least one leg extends transversely to the common plane at least partially through the through-openings and each conductor winding is arranged in each case running parallel to the common plane on in each case one of the layers around in each case at least one leg, no core part being provided on a side of the transformer opposite the first core part extending parallel to the common plane.

3. A transformer comprising:
a layered sequence of insulating layers transverse to a common plane, and
a plurality of at least two galvanically separated circuits, each circuit comprising:
at least one conductor winding, and
a common magnetic core only partially surrounding the layered sequence and acting on the plurality of at least two circuits, the core having a plurality of legs extending transverse to the common plane, each leg having a first and a second end face wherein only each first end is connected to a common core part extending parallel to the common plane and each second end is without connection to a further core part,
wherein through-openings are provided in the layered sequence and at least one leg extends at least partially through the through openings, and each conductor winding is arranged extending parallel to the common plane on a respective one of the layers around a respective at least one leg.

4. The transformer according to claim 1, further comprising:
a shielding surface extending parallel to the common plane, the shielding surface arranged on at least one of the layers, or
a shielding surface extending parallel to the common plane, the shielding surface arranged at least on the side of the transformer opposite the core part extending parallel to the common plane, which shielding surface limits the layered sequence towards this side.

5. The transformer according to claim 4, wherein each shield surface is formed with through-openings aligned with the through-openings.

6. The transformer according to claim 5, wherein recesses are provided between the through-openings of each shield surface.

7. The transformer according to claim 1, wherein:
at least one of the circuits comprises two conductor windings arranged in parallel on the same layer or on different layers within the layered sequence, and/or
at least one of the circuits comprises at least three conductor windings arranged in parallel on the same layer and/or on different layers within the layered sequence.

8. (canceled)

9. The transformer according to claim 1, wherein the conductor windings of a common circuit are electrically conductively connected to one another via electrical connections.

10. The transformer according to claim 1, wherein at least one of the circuits is electrically coupled to an electronic circuit adapted to adjust the transmission behavior.

11. The transformer according to claim 2, further comprising:
a shielding surface extending parallel to the common plane, the shielding surface arranged on at least one of the layers, or
a shielding surface extending parallel to the common plane, the shielding surface arranged at least on the side of the transformer opposite the first core part extending parallel to the common plane, which shielding surface limits the layered sequence towards this side.

12. The transformer according to claim 11, wherein each shield surface is formed with through-openings aligned with the through-openings.

13. The transformer according to claim 12, wherein recesses are provided between the through-openings of each shield surface.

14. The transformer according to claim 2, wherein:
at least one of the circuits comprises two conductor windings arranged in parallel on the same layer or on different layers within the layered sequence, and/or
at least one of the circuits comprises at least three conductor windings arranged in parallel on the same layer and/or on different layers within the layered sequence.

15. The transformer according to claim 2, wherein the conductor windings of a common circuit are electrically conductively connected to one another via electrical connections.

16. The transformer according to claim 2, wherein at least one of the circuits is electrically coupled to an electronic circuit adapted to adjust the transmission behavior.

17. The transformer according to claim 3, further comprising:
a shielding surface extending parallel to the common plane, the shielding surface arranged on at least one of the layers, or
a shielding surface extending parallel to the common plane, the shielding surface arranged at least on the side of the transformer opposite the common core part extending parallel to the common plane, which shielding surface limits the layered sequence towards this side.

18. The transformer according to claim 17, wherein each shield surface is formed with through-openings aligned with the through-openings.

19. The transformer according to claim 18, wherein recesses are provided between the through-openings of each shield surface.

20. The transformer according to claim 3, wherein:
at least one of the circuits comprises two conductor windings arranged in parallel on the same layer or on different layers within the layered sequence, and/or
at least one of the circuits comprises at least three conductor windings arranged in parallel on the same layer and/or on different layers within the layered sequence.

21. The transformer according to claim 3, wherein the conductor windings of a common circuit are electrically conductively connected to one another via electrical connections.

22. The transformer according to claim 3, wherein at least one of the circuits is electrically coupled to an electronic circuit adapted to adjust the transmission behavior.
